(19) United States
(12) Patent Application Publication
(10) Pub. No.: US 2024/0053200 A1
(43) Pub. Date: Feb. 15, 2024

(54) DETECTION AND IDENTIFICATION OF BODY FLUID TRACES WITH STAND-OFF RAMAN SPECTROSCOPY

(71) Applicant: The Research Foundation for the State University of New York, Albany, NY (US)

(72) Inventors: Igor Lednev, Glenmont, NY (US); Lamyaa Almehmadi, Guilderland, NY (US)

(21) Appl. No.: 18/234,204

(22) Filed: Aug. 15, 2023

Related U.S. Application Data
(60) Provisional application No. 63/398,122, filed on Aug. 15, 2022.

(51) Int. Cl. G01J 3/44; G01J 3/02; G01N 21/65

(52) U.S. Cl. CPC G01J 3/44; G01J 3/0218; G01J 3/0272; G01J 3/0291; G01N 21/65; G01J 2003/1213

(57) ABSTRACT

A system and method for utilizing Raman spectroscopy to detect and identify a fluid sample or stain in situ to determine the presence of body fluids. A portable Raman spectrometer performs stand-off Raman spectroscopy on suspected body fluids to detect and identify their actual presence, such as blood or semen. The portable Raman spectrometer can include a stand-off attachment to allow the proper distance between the spectrometer and fluid sample for optimal visual and statistical analysis of spectral data.

### CROSS-REFERENCE TO RELATED APPLICATION

This application claims the benefit of U.S. Provisional Application No. 63/398,122, filed Aug. 15, 2022, the entirety of which is hereby incorporated herein by this reference.

### BACKGROUND OF THE INVENTION

### 1. Field of the Invention

The present invention generally relates to Raman spectroscopy and chemical analysis. More particularly, the present invention relates to a system and method for utilizing Raman spectroscopy to detect and identify a fluid sample or stain to determine the presence of body fluids.

### 2. Description of the Related Art

Body fluids are one of the most significant pieces of evidence in crime scenes or incidents. This is because DNA can be extracted from body fluids to generate information about an individual's identity and traits. Such information could help identify suspects and provide valuable evidentiary leads related to a search.

Several tests have been developed to identify biological stains. However, most in-field tests designed for body fluids identification are non-universal and presumptive with possible false positives, leading to misclassified stains and overuse of evidence for multiple testing. Only when a stain is concluded to be of interest, it is then transferred to a lab for further confirmatory tests, which are labor-intensive and time-consuming. Thus, there is a need for modern technology to improve the body fluids identification process.

Raman spectroscopy has shown its capability to be a universal and non-destructive method for body fluids detection and identification. Raman spectroscopy is an analytical technique where scattered light is used to measure the vibrational energy modes of a sample. Raman spectroscopy can provide both chemical and structural information, as well as the identification of substances through their characteristic Raman “fingerprint.” Raman spectroscopy extracts this information through the detection of Raman scattering from the sample.

In Raman spectroscopy, inelastic scattered light is collected by irradiating a monochromatic light on a sample, as shown in prior art FIG. 1. As a result, vibrational modes of molecules are probed without the need for labels or special reagents. As Raman spectroscopy requires no or little sample preparation, it is ideal for cases where sample preservation is important. Stand-off Raman spectroscopy provides higher flexibility to probe materials from different distances, potentially reaching to kilometers. The stand-off measurements capability can also be coupled to portable or handheld instruments allowing in-field and remote sensing. In addition, stand-off Raman spectroscopy can be easily adopted for mapping a large area for detecting traces of evidence including biological stains. Several applications have been demonstrated with stand-off Raman spectroscopy, such as drug and harmful chemical detection, planetary exploration, and architecture characterization.

Usually, when a portable spectrometer is used to collect Raman spectra of a biological or fluid sample, complete or close contact of a spectrometer probe to a sample is needed. As a result, contamination from the sample or the spectrometer can be transferred, thus complicating the analysis. Furthermore, an investigator must be within reach of the sample even with the possible hazardous/biohazardous implications from unknown materials, and samples that are hardly accessible by either the investigator or the Raman spectrometer probe increases the hurdle of the process.

Accordingly, an improved system and method of remote Raman spectroscopy that addressed the problems with the existing art sampling fluid or biological materials would be advantageous. It is thus to such an improved system and method that the present invention is primarily directed.

### BRIEF SUMMARY OF THE INVENTION

Briefly described, the present system and method using stand-off Raman spectroscopy, which enables collecting the Raman signal of fluid samples from a longer distance. Biological stains play a significant role in crime scene investigations as a major source of DNA evidence. Raman spectroscopy has a great potential for becoming a universal tool for confirmatory identification of body fluid traces. One can use stand-off Raman spectroscopy for scanning a relatively large surface area for the detection and identification of biological stains at the crime scene. Using stand-off approach is also helpful for safety reasons if the crime scene is potentially contaminated with biohazardous materials.

Here, the invention involves the applicability of stand-off Raman spectroscopy to detect and identify body fluids using a hand-held Raman spectrometer. Among all types of body fluids, blood is commonly found in crime scene investigations involving violence. Therefore, the present system can analyze peripheral blood stains using a hand-held Raman spectrometer coupled with a stand-off attachment via visual and statistical analysis of spectral data. One can also use a benchtop Raman microscope for comparison of a physical sample in the lab with the remotely gathered data to confirm the analysis. The present invention therefore advantageously provides a stand-off Raman spectroscopy combined with statistical analysis to detect and identify body fluids at the crime scene.

In one embodiment, the invention includes a portable Raman spectrometer, that includes a body that has a computer platform in selective communication with other computer devices, and a spectrometer within the body that selectively receives and records a light scatter. The body includes a laser selectively projecting a sensing laser, and a focusing optic through which passes the sensing laser and the light scatter. There is also an optimal distancing device connected to the body, the optimal distancing device visually indicating the optimal distance for probing a fluid sample with spectroscopy.

In alternate embodiments, the optimal distance device can be a physical attachment to the body or a light projection from the body. The computer platform can be configured to be connected to a data store and selectively relay scanned spectroscopic data thereto. Further, the spectrometer can use an orbital raster scan mode to probe the fluid sample, and the body can also include a display for selective display of information received from a remote computer across a network, such as identification data for the nature of the fluid sample.

In another embodiment, the invention includes a system to perform spectroscopic analysis on a remote fluid sample that includes a Raman spectrometer having a body, with a computer platform in selective communication with other computer devices across a network. The spectrometer selectively receives and records a light scatter, and a laser is in the body that selectively projecting a sensing laser. The body also includes a focusing optic through which passes the sensing laser and the light scatter, and there is also an optimal distancing device connected to the body that visually indicates the optimal distance for probing a fluid with spectroscopy. There is a remote processor in selective communication with the computer platform of the body across the network, and the spectrometer can selectively probe a remote fluid sample obtaining spectroscopic data therefrom and relay the spectroscopic data to the processor for analysis.

In a further embodiment, the invention includes a method of utilizing Raman spectroscopy to detect and identify a fluid by the steps of scanning a fluid sample with a portable Raman spectrometer, the spectrometer including a computer platform in selective communication with other computer devices across a network and the spectrometer selectively receiving and recording a light scatter from a laser selectively projecting a sensing laser. The method continues with the step of collecting spectroscopic data from a fluid sample at the computer platform of the spectrometer, and then transmitting the spectroscopic data from the computer platform of the spectrometer to a processor across a network, where the processor is in selective communication with the computer platform of the body across the network. The method then includes analyzing the received spectroscopic data at the processor.

In embodiments, the method can include the step of communicating analyzed data from the processor to the computer platform of the spectrometer, and further including displaying the analyzed data received from the processor on a display of the spectrometer. If a data store is in selective communication with the processor and the computer platform of the spectrometer, the method can further include the step of the computer platform transmitting spectroscopic data to the data store.

In a further embodiment, if the system includes a Raman microscope is located remotely from the spectrometer, then the method can further include the steps of collecting a physical specimen of the fluid sample, then analyzing the collected physical sample at the Raman microscope and comparing the analyzed data from the spectroscopic data transmitting from the spectrometer against the analyzed physical sample data of the Raman microscope.

The present invention therefore provides an advantage in that it allows the safe and efficient collection and analysis of spectroscopic data of fluids with a portable Raman spectrometer. The present invention thus has industrial and practical applicability in that it can be used to provide timely analysis of suspect fluids at crime scenes and other remote locations of interest. Other advantages and applications of the present invention will be apparent to one of skill in the art from review of the disclosure of the present application.

### BRIEF DESCRIPTION OF THE DRAWINGS

FIG. 1 is a diagram of known three types of scattering processes in the prior art that occur when light interacts with a molecule.

FIG. 2 is a schematic diagram of an exemplary Raman spectrometer.

FIG. 3 is a schematic diagram of one embodiment of the present system to remotely scan a fluid sample with a portable Raman spectrometer that is in communication with other computer devices across a network.

FIG. 4 is a picture of a Laser spot shape on a dried fluid sample positioned by the hand-held MIRA XTR Raman spectrometer equipped with the stand-off attachment with an orbital raster scan mode of spectroscopic analysis being used.

FIG. 5 is a graph of preprocessed averaged peripheral blood spectra collected by a benchtop XploRA Plus microscope and a hand-held Mira XTR DS spectrometer equipped with a stand-off attachment.

FIG. 6 is a graph of strict class prediction scores plot for external validation of a model for the spectroscopic identification of traces of five main body fluids.

### DETAILED DESCRIPTION

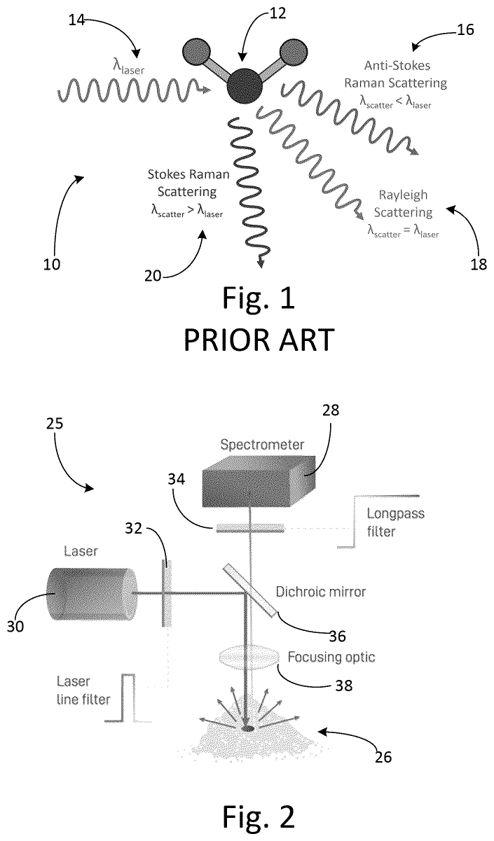

With reference to the figures in which like numerals represent like elements throughout the several views, FIG. 1 is a prior art diagram 10 that illustrates three types of scattering processes that can occur when light interacts with a molecule 12. When light is scattered by molecule 12 illuminated with a concentrated light source, such as a laser 14, the oscillating electromagnetic field of a photon induces a polarization of the molecular electron cloud which leaves the molecule in a higher energy state with the energy of the photon transferred to the molecule. This can be considered as the formation of a very short-lived complex between the photon and molecule which is commonly called the virtual state of the molecule. The virtual state is not stable and the photon is reemitted, almost immediately, as scattered light.

In a majority of scattering events, the energy of the molecule is unchanged after its interaction with the photon and the energy, and therefore the wavelength, of the scattered photon is equal to that of the incident photon. This is called elastic (energy of scattering particle is conserved) or Rayleigh scattering 18 and is the dominant process.

In a rarer event, Raman scattering 20 occurs, which is an inelastic scattering process with a transfer of energy between the molecule and scattered photon. If the molecule gains energy from the photon during the scattering (excited to a higher vibrational level) then the scattered photon loses energy and its wavelength increases which is called Stokes Raman scattering 20. Inversely, if the molecule loses energy by relaxing to a lower vibrational level the scattered photon gains the corresponding energy and its wavelength decreases, which is called Anti-Stokes Raman scattering 16.

Quantum mechanically, Stokes scattering 20 and Anti-Stokes scattering 14 are equally likely processes. However, with an ensemble of molecules 12, the majority of molecules will be in the ground vibrational level (Boltzmann distribution) and Stokes scatter 14 is the statistically more probable process. As a result, the Stokes Raman scatter 14 is always more intense than the anti-Stokes scatter 16 and for this reason, it is the Stokes Raman scatter 20 that is primarily (but not exclusively) measured in Raman spectroscopy.

The wavelength of the Stokes Raman scattered light 20 will depend on the wavelength of the excitation light, such as laser 14. This makes the Raman scatter 20 wavelength an impractical number for comparison between spectra measured using different lasers. The Raman scatter 20 position is therefore converted to a Raman shift away from excitation wavelength. Thus, Raman spectroscopy is accomplished by use of the Raman shift equation:

$$Δ \overline{v} ( {cm}^{- 1} ) = ( \frac{1}{{λ}_{0} ( nm )} - \frac{1}{{λ}_{1} ( nm )} ) \times \frac{( {10}^{7} nm )}{( cm )}$$

The first term is the wavenumber Raman shift in cm⁻¹, λ(0) is the wavelength of the excitation laser in nm, and λ(1) is the wavelength of the Raman scatter in nm. A Raman spectrometer system, such as that shown in FIG. 2, requires three primary components: high-intensity laser 30, a sample optical interface 38, and a spectrometer 28.

The laser 30 acts as the excitation source which provides the high intensity light required to obtain sufficient Raman signals for detection. Raman scattering occurs at a probability of one part in a million, so high laser intensities are required to balance out the rarity of Raman scatter. Although any wavelength can be used to generate a Raman spectrum, the excitation wavelength is the defining factor underlying Raman intensity.

The scattering intensity is inversely proportional with the excitation wavelength to the fourth power (λ⁻⁴), which means shorter laser wavelengths yield a greater Raman signal and vice versa. Therefore, an ultraviolet Raman laser can obtain a spectrum which is orders of magnitude more intense than that of a near-infrared laser. Conversely, shorter wavelengths are more likely to induce autofluorescence than longer ones, which will obscure the Raman signal. Selecting the right laser wavelength subsequently depends primarily on sample type, balancing signal intensity against autofluorescence for the material under investigation.

With reference to FIG. 2, the Raman spectrometer system 25 has a sample interface with focusing optic 38 that directs and focuses the incident beam on the sample 26, and which collects the comparatively weak Raman emissions for routing to the spectrometer 28 itself. A long-pass dichroic mirror 36 is commonly used to reflect shortwave laser light onto the sample 26 and to transmit Raman scattered light through to the spectrometer 28, as shown in the diagram of the system 25 in FIG. 2. An additional long-pass filter 34 with a minimum optical density (OD) is typically integrated into the sampling optics to block the overwhelming Rayleigh scatter from the excitation laser light 32. Sampling optics for Raman systems come in various optical configurations, some use fiber optic coupling to allow the sampling optics to be integrated into a probe for use at a distance from the spectrometer 28, while others use fully integrated sampling optics to reduce size and optical losses within the system 25.

Further, the Raman spectrometer 28 simultaneously captures and detects all the light transmitted by the sample interface, focusing optic 38, reporting a spectrum as a function of Raman shift relative to laser 30 frequency. The system 25 can also use a laser line filter 32 to control the laser frequency for measurement. This allows the control of sufficient range, signal strength, and optical resolution. Key performance properties include high sensitivity, a good signal-to-noise ratio, and a high light collection power, expressed as the f-number (f/#) or numerical aperture (NA). The Spectrometer 28 range is another important parameter to consider. This refers to the Raman shift frequency range, which is typically broken up into the fingerprint region (<1500 cm⁻¹), used for material identification, and the functional region (<3600 cm⁻¹), which provides additional chemical bond information used in research and specialized applications.

Biological stains play a significant role in crime scene investigations as a major source of DNA evidence. Raman spectroscopy has a great potential for becoming a universal tool for confirmatory identification of body fluid traces, and one can use stand-off Raman spectroscopy for scanning a relatively large surface area for the detection and identification of biological stains at the crime scene. The use of a stand-off approach is also helpful for safety reasons if the crime scene is potentially contaminated with biohazardous materials.

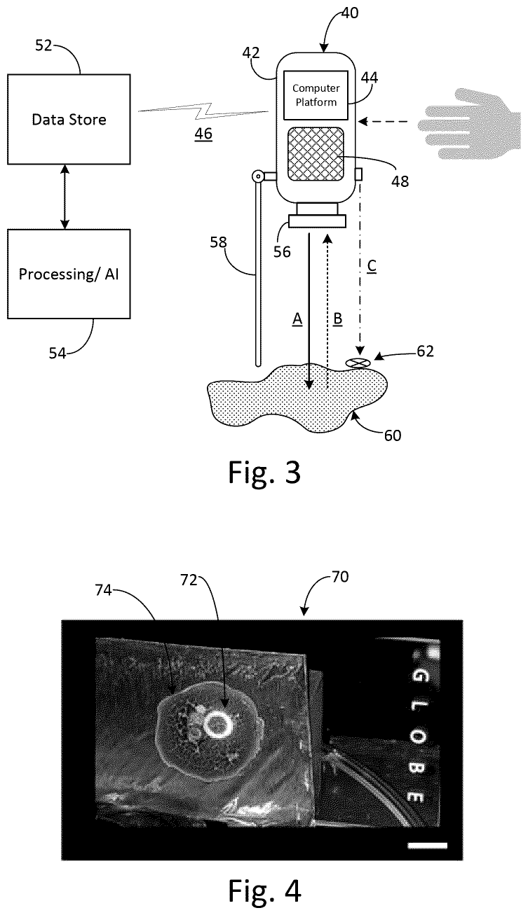

Among all types of body fluids, blood is commonly found in crime scene investigations involving violence. Therefore, the present system has be demonstrated as effective in the analysis of peripheral blood stains using a hand-held Raman spectrometer (42 in FIG. 3) coupled with stand-off attachment (physical attachment 58 or visual light projection 62) via visual and statistical analysis of Rama spectral data. Also a benchtop Raman microscope can be used to confirm the remote analysis for comparison.

Thus, in one embodiment, the portable Raman spectrometer 40 includes a body 42 that has a computer platform 44 in selective communication, via a wireless link 46 in this embodiment, with other computer devices across a network, such as a data store 52 and processor 54, which can include an artificial intelligence (AI) module for spectroscopic analysis. The spectrometer 40 selectively receives and records a light scatter (Arrow B) and has a laser selectively projecting a sensing laser (Arrow A). There is a focusing optic (lens 48) through which passes the sensing laser light (Arrow A) and the light scatter (Arrow B).

The body 42 includes an optimal distancing device connected to the body 42 that visually indicates the optimal distance for probing a fluid sample 46 with spectroscopy. In one embodiment, the optimal distance device is a physical attachment 58 to the body 42, shown here as a swinging ruler that indicates the optimal distance by having a far end positioned proximate to the fluid sample 60. Alternately, the optimal distance device can a light projection (Line C) from the body 42. In such embodiment, the light projection (Line C) projects a light target 62 that appears clear at the optimal distance of the lens 56 from the fluid sample 60 for optimal Raman spectroscopy.

The computer platform 44 can be configured to be connected to a data store 52 and selectively relay scanned spectroscopic data thereto. Further, the spectrometer 40 can use an orbital raster scan mode to probe the fluid sample 60. Additionally, the spectrometer 40 can further include a display 48 on the body 42 for selective display of information received from a remote computer across a network, such as processor 54 or data store 52.

In another embodiment, the invention includes a system to perform spectroscopic analysis on a remote fluid sample 60. The system includes a Raman spectrometer 40 with a body 42, including a computer platform 44 in selective communication with other computer devices, such as data store 52 and processor 54, here via the wireless link 46 across a network, such as the Internet. The spectrometer 40 selectively receives and records a light scatter (Line B). In the body 42, there is a laser selectively projecting a sensing laser (Line A) through a focusing optic (lens 56) through which passes the sensing laser (Line A) and the light scatter (Line B).

Further in the system, the body 42 includes and an optimal distancing device connected to the body 42, such as physical attachment 58 or light projection (Line C), with the optimal distancing device visually indicating the optimal distance for probing a fluid sample 60 with spectroscopy. There is a processor 54 in selective communication with the computer platform 44 of the body 42 across the network, and the spectrometer 40 selectively probes a remote fluid sample 60 obtaining spectroscopic data therefrom and relays the spectroscopic data to the processor 54 for analysis.

The processor 54 can further communicate analyzed data to the computer platform 44 of the spectrometer 40 and can further include a data store 52 in selective communication with the processor 54 and the computer platform 44 of the spectrometer 40. The processor 54 can store analyzed data at data store 52. The spectrometer 40 can use an orbital raster scan mode to probe the fluid sample 60. The spectrometer 40 can further include a display 48 for selective display of information received from the processor 54, such as analysis data for the fluid sample 60.

FIG. 4 is a picture 70 of a laser spot shape 72 on a dried fluid blood sample 74 sample positioned by the hand-held MIRA XTR Raman spectrometer (such as spectrometer 40 in FIG. 3) equipped with the stand-off attachment (physical attachment 58 or light projection (Line C) with an orbital raster scan mode of spectroscopic analysis being used. The scale bar represents 5 mm. With reference to FIG. 4, the efficacy of the system was demonstrated with fresh peripheral blood samples were collected from a volunteer, following a protocol approved by the Institutional Review Board (IRB) at the University at Albany, State University of New York, by means of a finger prick. Three bloodstain samples (such as blood sample 74) were prepared separately, two of them on the same day and one on a different day. For each sample, 40 μL of peripheral blood were deposited on an aluminum foil-covered glass slide and left to dry at room temperature. The aluminum-foil-covered glass slides were cleaned with ethanol and dry prior to the blood deposition. The large sample volume of 40 μL was used to accommodate the large laser spot area for stand-off measurements. The large sample area allowed for collecting Raman spectra while the scanning laser spot 72 was fully within the dried sample and allowed for collecting spectra from multiple regions.

This study used two different Raman instruments for comparison: a benchtop instrument XploRA Plus confocal Raman Microscope (HORIBA) and a hand-held Mira XTR DS Raman spectrometer equipped with a stand-off attachment (Metrohm) with spectral resolutions of 4 cm⁻¹ and 8-10 cm⁻¹ for each instrument, respectively. The spectral collection parameters of both instruments are summarized in Table 1 below. Briefly, 785-nm excitation laser wavelength was used to collect spectra of dry peripheral bloodstains (blood sample 74) with 10 seconds acquisition time and 33 accumulations for both instruments. In the case of the XploRA Plus microscope, automatic mapping was used to collect spectra from different spots of the sample using 50× objective and 7 mW laser power. In the case of the hand-held Mira XTR DS Raman spectrometer equipped with the stand-off attachment, spectra were collected by manually positioning the laser spot on different regions while keeping a 0.25 m distance between the stand-off attachment and the sample. These spectra were collected using the orbital raster scan mode with a 60 mW laser power. The orbital raster scan mode enables spectral collection from larger areas and thus provides more representative spectra and quicker sampling.

For illustration, FIG. 4 further shows the laser spot on dried blood when the orbital raster scan mode is used. Twenty-six spectra were collected by the XploRA Plus microscope, and twelve spectra were collected by the hand-held Mira XTR DS spectrometer equipped with the stand-of attachment. Nine of the twelve spectra collected by the hand-held Mira XTR equipped with the stand-off attachment were from the same sample used for the XploRA plus measurements, and the rest were collected from two samples prepared on a different day. The use of multiple samples prepared on different days accounts for unintentional variations caused by instrument calibration or sample preparation. All spectra were subjected to both visual and statistical analysis. Additionally, three spectra were collected from each point using the hand-held spectrometer (such as spectrometer 40) to assess a potential sample photodegradation.

TABLE 1
Instrument and spectral collection parameters used in this study.

| | | |
|---|---|---|
| | | Mira XTR DS |
| Instrument | XploRA Plus | (Stand-off attachment) |

| | | | | |
|---|---|---|---|---|
| Laser | 785 | nm | 785 | nm |
| Spectral Resolution | 4 | cm−¹ | 8-10 | cm−¹ |
| Laser Power | 7 | mW | 60 | mW |

| | | |
|---|---|---|
| Objective | 50× | Stand-off attachment: |
| | | 0.25 m distance |

| | | | | |
|---|---|---|---|---|
| Acquisition time | 10 | seconds | 10 | seconds |

| | | |
|---|---|---|
| Accumulations | 3 | 3 |
| Spectral collection | Mapping | Manual positioning |
| method | | on different |
| | | sample regions |

All collected spectra were inspected visually for any sample degradation and low signal-to-noise ratio. Spectra with a low signal-to-noise ratio were discarded before conducting statistical analysis. The spectra were interpolated to align all x-axis spectral points with the x-axis spectral points used in the SVM-DA model data set.

The identification of the collected peripheral blood spectra was conducted statistically using a known body fluid identification and differentiation SVM-DA model. Before subjecting the collected spectra to the model, spectra were preprocessed following the same steps used for the dataset of the original model. Briefly, using PLS Toolbox (Eigenvector Research, Inc, Wenatchee, WA) within MATLAB (version 2021a) (Mathworks, Inc., Natick, MA), the raw spectra were truncated to the region 400-1700 cm⁻¹, baseline corrected using automatic weighted least squares (polynomial order: 5) and normalized by total area. Data were mean-centered before applying the model. One known SVM-DA model included five main body fluids in the calibration dataset (n=3151), consisting of 60 donors. It is important to note that these spectra were collected by a different benchtop instrument, an inVia Raman microscope (Renishaw, Inc., Hoffman Estates, IL), which allowed for additional testing of our model performance when different instruments are used for spectral collection.

This study aims to introduce stand-off Raman spectroscopy combined with advanced statistics as a new body fluids detection and identification method. Stand-off measurements offer the ability to collect Raman signals from a longer distance, allowing for conveniently probing stains. To demonstrate the potential of this method, peripheral blood stains deposited on aluminum foil-covered glass slides were investigated. A hand-held Raman spectrometer, Metrohm Mira XTR DS, equipped with a stand-off attachment, was used to conduct stand-off Raman spectral acquisition from a 0.25 m distance. Also, a benchtop Raman microscope, HORIBA XploRA Plus, was used to collect Raman spectra of a peripheral blood sample for comparison. The spectra collected were analyzed both visually and statistically.

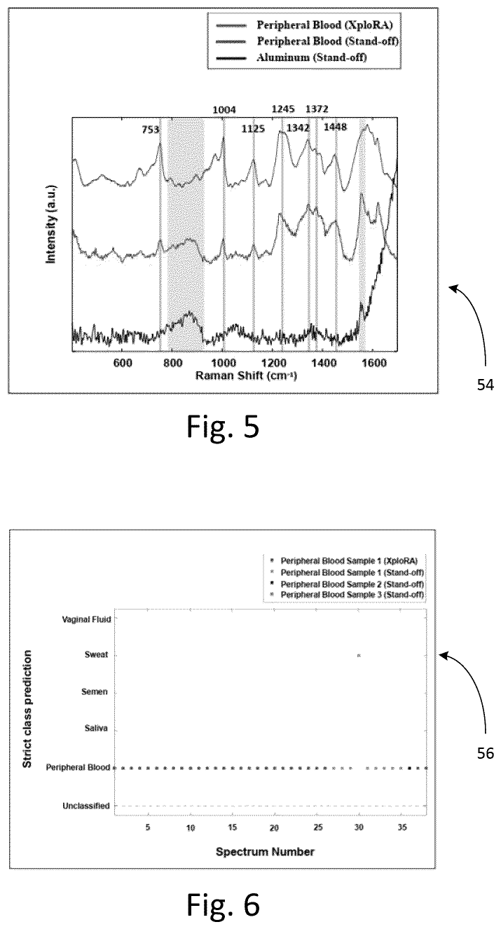

FIG. 5 is a graph of the preprocessed averaged peripheral blood spectra collected by a benchtop XploRA Plus microscope and a hand-held Mira XTR DS spectrometer equipped with a stand-off attachment. In addition, an unaveraged preprocessed spectrum of aluminum substrate collected by the hand-held instrument is included for visual comparison. Highlighted in gray regions where the aluminum Raman signal has a high spectral contribution to the blood stain spectrum.

FIG. 5 illustrates the averaged spectra of blood stains composed of twenty-six spectra in the case of the benchtop HORIBA XploRA Plus Raman microscope and twelve spectra in the case of the handheld Mira XTR DS Raman spectrometer equipped with the stand-off attachment. An individual Raman spectrum of aluminum foil collected using the hand-held Mira XTR DS Raman spectrometer equipped with the stand-off attachment is also included for background signal comparisons. Visually, the Raman spectra of peripheral blood stains collected with both instruments are in agreement with previously reported results. Three exceptions are observed for the spectra collected using the hand-held instrument, the contribution of aluminum substrate Raman signal to the peripheral blood spectra, the lower spectral resolution, and missing some Raman bands. The aluminum Raman signal overlapped with the blood Raman signal, specifically at the regions 770 cm⁻¹ to 925 cm⁻¹ and at the band 1555 cm⁻¹, as highlighted in gray.

The contribution of the aluminum signal is likely because of larger depth of field when using the hand-held Raman spectrometer unlike in the case of benchtop Raman spectrometers equipped with objectives. The transmittance of light at 785 nm was measured through 0.2 mm layer. The results of measuring the transmitted light showed a level of transmittance of light at 785 nm indicating the possibility of the 785 nm laser penetrating through blood stains. Other studies regarding the penetration of 785 nm laser wavelength through powders have been also reported with a depth of 1-3 mm. In addition to the laser penetration, small gaps formed within dried blood stains could allow for further collecting the Raman signal of the substrate.

Visual inspection of the spectra collected by the XploRA Plus microscope and the hand-held Mira XTR DS spectrometer equipped with the stand-off attachment shows high similarities and includes indicative blood biomarker bands. Specifically, the bands at 7536 cm⁻¹, 1125 cm⁻¹, and 1372 cm⁻¹ are assigned to the heme group. Other bands assigned to chemical groups reported in blood spectra are also detected, such as the bands at 1004 cm⁻¹ assigned to phenylalanine, 1245 to amide III, 1342 amino acids, and 1448 to CH2/CH3. The spectra collected were then analyzed statistically for body fluid identification using our previously reported SVM-DA body fluids identification model. The statistical analysis provided automatic identification of body fluids.

FIG. 6 is a graph 56 of strict class prediction scores plot for external validation of a model for the spectroscopic identification of traces of five main body fluids. The data are shown for spectra obtained from a single peripheral blood sample collected by the benchtop XploRA Plus microscope and three peripheral blood samples collected by the hand-held Mira XTR DS spectrometer equipped with the stand-off attachment.

FIG. 6 shows a 100% prediction of the peripheral blood samples using the SVM-DA model based on spectra collected using both instruments. This analysis allowed the 100% classification of peripheral blood spectra collected by the XploRA Plus instrument, which differs from the instrument used for 600 800 1000 1200 1400 1600 Raman Shift (cm⁻¹) Intensity (a.u.). To calibrate the model, we demonstrated that our SVM-DA model is not dependent on a specific type of instrument. The model was calibrated with spectra collected using the Renishaw Raman microscope.

With reference again to FIGS. 2 and 3, the present invention further provides a method of utilizing Raman spectroscopy to detect and identify a fluid sample 60, including the steps of scanning a fluid sample 60 with a portable Raman spectrometer 40, including a computer platform 44 in selective communication with other computer devices, such as date store 52 and processor 54, across a network, such as the Internet through a wireless link 46. In the method, the spectrometer 40 is selectively receiving and recording a light scatter (Line B) from a laser selectively projecting a sensing laser (line A). The method then includes collecting spectroscopic data (via Line B) from a fluid sample 60 (or blood sample 74 in FIG. 4) at the computer platform 44 of the spectrometer 40, and transmitting the spectroscopic data from the computer platform 44 of the spectrometer 40 to a processor 54 across a network, the processor 54 in selective communication with the computer platform 44 of the body 42 across the network. Then the method includes analyzing the received spectroscopic data at the processor 54.

In one embodiment, the method further includes the step of optimally distancing the spectrometer 40 from the fluid sample 60 for probing the fluid sample 60 with spectroscopy. The optimal distancing can occur through the use of the physical attachment 58 or light projection (Line C and light target 62).

The method can include the step of communicating analyzed data from the processor 54 to the computer platform of the spectrometer 40, and then displaying the analyzed data received from the processor 54 on the spectrometer 40, on a display 48 thereof. If a data store 52 is in selective communication with the processor 54 and the computer platform 44 of the spectrometer 40, then the method can further include the step of the computer platform 44 transmitting spectroscopic data to the data store 52.

If a lab-based Raman microscope is located remotely from the spectrometer 40, the method can further include the steps of collecting a physical specimen of the fluid sample 60, analyzing the collected physical sample at the Raman microscope, and then and comparing the analyzed data from the spectroscopic data transmitting from the spectrometer 40 against the analyzed physical sample data of the Raman microscope. These steps would verify the remote analysis of the portable spectrometer 40 and allow further refinement of the predictive capability of the spectrometer 40.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A portable Raman spectrometer, comprising:
a body, including:
a computer platform in selective communication with other computer devices;
a spectrometer selectively receiving and recording a light scatter;
a laser selectively projecting a sensing laser; and
a focusing optic through which passes the sensing laser and the light scatter; and
an optimal distancing device connected to the body, the optimal distancing device visually indicating the optimal distance for probing a fluid sample with spectroscopy.

2. The spectrometer of claim 1, wherein the optimal distance device is a physical attachment to the body.

3. The spectrometer of claim 1, wherein the optimal distance device is a light projection from the body.

4. The spectrometer of claim 1, wherein the computer platform is configured to be connected to a data store and selectively relay scanned spectroscopic data thereto.

5. The spectrometer of claim 1, wherein the spectrometer uses an orbital raster scan mode to probe the fluid sample.

6. The spectrometer of claim 4, wherein the spectrometer further including a display for selective display of information received from a remote computer across a network.

7. A system to perform spectroscopic analysis on a remote fluid sample, comprising:
a Raman spectrometer, including:
a body, including:
a computer platform in selective communication with other computer devices;
a spectrometer selectively receiving and recording a light scatter;
a laser selectively projecting a sensing laser;
a focusing optic through which passes the sensing laser and the light scatter; and
an optimal distancing device connected to the body, the optimal distancing device visually indicating the optimal distance for probing a fluid with spectroscopy; and
a processor in selective communication with the computer platform of the body across a network,
wherein the spectrometer selectively probes a remote fluid sample obtaining spectroscopic data therefrom and relays the spectroscopic data to the processor for analysis.

8. The system of claim 7, wherein the processor further communicates analyzed data to the computer platform of the spectrometer.

9. The system of claim 7, further including a data store in selective communication with the processor and the computer platform of the spectrometer.

10. The system of claim 7, wherein the optimal distance device of the body is a physical attachment to the body.

11. The system of claim 7, wherein the optimal distance device of the body is a light projection from the body.

12. The system of claim 9, wherein the processor stores analyzed data at the data store.

13. The system of claim 7, wherein the spectrometer uses an orbital raster scan mode to probe the fluid sample.

14. The system of claim 7, wherein the spectrometer further including a display for selective display of information received from the processor.

15. A method of utilizing Raman spectroscopy to detect and identify a fluid, comprising:
scanning a fluid sample with a portable Raman spectrometer having a body thereof including a computer platform in selective communication with other computer devices across a network, the spectrometer selectively receiving and recording a light scatter from a laser selectively projecting a sensing laser;
collecting spectroscopic data from a fluid sample at the computer platform of the spectrometer;
transmitting the spectroscopic data from the computer platform of the spectrometer to a processor across a network, the processor in selective communication with the computer platform of the body across the network; and
analyzing the received spectroscopic data at the processor.

16. The method of claim 15, further including optimally distancing the spectrometer from the fluid sample for probing the fluid sample with spectroscopy.

17. The method of claim 15, further including communicating analyzed data from the processor to the computer platform of the spectrometer.

18. The method of claim 17, further including displaying the analyzed data received from the processor on the spectrometer.

19. The method of claim 15, wherein a data store in selective communication with the processor and the computer platform of the spectrometer, and further including the computer platform transmitting spectroscopic data to the data store.

20. The method of claim 15, wherein a Raman microscope is located remotely from the spectrometer, and further including:
collecting a physical specimen of the fluid sample;
analyzing the collected physical sample at the Raman microscope; and
comparing the analyzed data from the spectroscopic data transmitting from the spectrometer against the analyzed physical sample data of the Raman microscope.
